(19) United States
(12) Patent Application Publication
(10) Pub. No.: US 2015/0011763 A1
(43) Pub. Date: Jan. 8, 2015

(54) SURFACE MODIFICATION OF METAL NANOSTRUCTURES

(71) Applicant: Carestream Health, Inc., Rochester, NY (US)

(72) Inventor: David R. Whitcomb, Woodbury, MN (US)

(21) Appl. No.: 14/306,664

(22) Filed: Jun. 17, 2014

Related U.S. Application Data
(60) Provisional application No. 61/842,405, filed on Jul. 3, 2013.

(51) Int. Cl. C07F 1/00

(52) U.S. Cl. CPC C07F 1/00
USPC 546/4; 556/112; 548/103

(57) ABSTRACT

A nanostructure comprising at least one metal nanowire comprising at least one surface, and at least one surface modifier disposed on the at least one surface, the at least one surface modifier comprising at least one linkage component, at least one nanowire binding moiety bonded to the at least one linkage component, and at least one surface modifying moiety also bonded to the at least one linkage component, where the at least one nanowire binding moiety is bonded to the at least one surface.

### CROSS REFERENCE TO RELATED APPLICATIONS

This application claims the benefit of U.S. Provisional Patent Application No. 61/842,405, filed Jul. 3, 2013, entitled “SURFACE MODIFICATION OF METAL NANOSTRUCTURES,” which is hereby incorporated by reference in its entirety.

### BACKGROUND

Silver nanowires have been reported to be able to form liquid crystalline phases. S. Murali, T. Xu, M. J. Kayatin, K. Pizarro, V. K. Radhakrishnan, D. Nepal, V. A. Davis, Langmuir 2010, 26(13), 11176, Alkanethiol self-assembled monolayers have been applied to the surface of silver nanowires. P. Andrew, A. Ilie, J. Phys. Conf. Series, 2007, 61, 36, Benzenethiol has been used to provide corrosion protection to silver nanowires. H. Qi, D. Alexson, O. Glembocki, S. M. Prokes, Nanotechnology, 2010, 21, 215706. Aqueous suspensions of binary self-assembled monolayer mixtures have been used to modify the surface of nanoparticles. A. Stewart, S. Zheng, M. R. McCourt, S. E. J. Bell, ACS Nano, 2012, 6(5), 3718, 3-Aininopropyltriethoxysilane has been used to modify the surface of nanowires. Y-H Yu, C-C Ma, C-C Teng, Y-L Huang, S-H Lee, I. Wang, M-H Wei, Materials Chemistry & Physics, 2012, 136, 334-40. U.S. Pat. No. 7,601,391 and U.S. Patent Application Publication 2008/0044657 to Woo et al, both disclose surface modification of nanoparticles. U.S. Pat. No. 8,383,682 to Dunbar discloses a composition comprising surface-modified nanoparticles.

### SUMMARY

Compositions comprising surface functionalized metal nanoparticles and methods of their formation are disclosed. Such functionalization can modify the chemical or surface properties of the metal nanoparticles, thereby enhancing their usefulness in electronics applications. We have discovered compositions that modify the surfaces of metal nanowires, giving them new and enhanced properties. Non-limiting examples of such properties include physical properties, binding capabilities, and reaction capabilities.

In some embodiments, a nanostructure is provided comprising at least one metal nanowire comprising at least one surface, and at least one surface modifier disposed on the at least one surface, the at least one surface modifier comprising at least one linkage component, at least one nanowire binding moiety bonded to the at least one linkage component, and at least one surface modifying moiety also bonded to the at least one linkage component, wherein the at least one nanowire binding moiety is bonded to the at least one surface.

In further embodiments, the linkage component comprises a linkage moiety. In some embodiments, the linkage moiety comprises a hydrocarbon. In some embodiments, the linkage moiety comprises an organometallic component. In some embodiments, the linkage moiety comprises a nonmetal. In some embodiments, the linkage moiety comprises a neutral moiety. In some embodiments, the linkage moiety does not comprise silicon.

In any of the above embodiments, the nanowire binding moiety may comprise sulfur, nitrogen, phosphorus, or an ionic substance. In some embodiments, the nanowire binding moiety comprises sulfur. In some embodiments, the nanowire binding moiety comprises phosphorus. In some embodiments, the nanowire binding moiety comprises nitrogen. In some embodiments, the nanowire binding moiety comprises an ionic component. In some embodiments, the nanowire binding moiety binds to the at least one surface through a dipolar bond.

In any of the above embodiments, the surface modifying moiety may comprise a ligand. In any of the above embodiments, the surface modifying moiety comprises an amine group. In any of the above embodiments, the surface modifying moiety comprises an epoxy group. In any of the above embodiments, the surface modifying moiety comprises a carboxylate group. In any of the above embodiments, the surface modifying moiety comprises a trifluormethyl group. In any of the above embodiments, the surface modifying moiety comprises a thiol group.

In any of the above embodiments, the nanowire binding moiety may comprise a thiol group. In any of the above embodiments, the nanowire binding moiety may comprise at least one fluorine atom.

In any of the above embodiments, the nanostructure may be hydrophobic. In any of the above embodiments, the nanostructure may be hydrophilic.

In some embodiments, the surface modifier comprises dodecanethiol.

In some embodiments, the surface modifier comprises a dithiol. In some embodiments, the surface modifier comprises 1,9-nonanedithiol. In some embodiments, the surface modifier comprises 1H,1H,2H,2H-perfluorodecanethiol.

In some embodiments, a method is provided comprising providing at least one metal nanowire comprising at least one surface, providing at least one surface modifier comprising at least one linkage component, at least one nanowire binding moiety bonded to the at least one linkage component, and at least one surface modifying moiety also bonded to the at least one linkage component, wherein the at least one nanowire binding moiety is bonded to the at least one surface; and combining the at least one metal nanowire and the at least one surface modifier, wherein, after combining the at least one nanowire and the at least one surface modifier, the at least one surface modifier is disposed on the at least one surface of the at least metal nanowire.

In some embodiments, prior to combining the at least one metal nanowire and the at least one surface modifier, the at least one metal nanowire exhibits a preexisting set of properties, and after the combining the at least one metal nanowire and the at least one surface modifier, the at least one metal nanowire exhibits a consequent set of properties, and wherein the consequent set of properties is different from the preexisting set of properties.

In some embodiments, the preexisting set of properties comprises a preexisting binding capability to bind with other substances and the consequent set of properties comprises a consequent binding capability to bind with other substances that is different from the preexisting binding capability to bind with other substances.

In some embodiments, the preexisting set of properties comprises a preexisting reaction capability to react with other substances and the consequent set of properties comprises a consequent reaction capability to react with other substances that is different from the preexisting reaction capability to react with other substances.

In some embodiments, the preexisting set of properties comprises a preexisting physical property and the consequent set of properties comprises a consequent physical property that is different from the preexisting physical property. In some embodiments, the preexisting physical property comprises a preexisting optical property and the consequent physical property comprises a consequent optical property that is different from the preexisting optical property. In some embodiments, the preexisting optical property comprises a preexisting haze and the consequent optical property comprises a consequent haze that is different from the preexisting haze. In some embodiments, the preexisting optical property comprises a preexisting refractive index and the consequent optical property comprises a consequent refractive index that is different from the preexisting refractive index. In some embodiments, the preexisting optical property comprises a preexisting reflection and the consequent optical property comprises a consequent reflection that is different from the preexisting reflection. In some embodiments, the preexisting optical property comprises a preexisting transmission and the consequent optical property comprises a consequent transmission that is different from the preexisting transmission. In some embodiments, the preexisting physical property comprises a preexisting capability to form a salt and the consequent physical property comprises a consequent capability to form a salt that is different from the preexisting capability to form a salt.

These embodiments and other variations and modifications may be better understood from the brief description of the drawings, description, exemplary embodiments, examples, and figures that follow. Any embodiments provided are given only by way of illustrative example. Other desirable objectives and advantages inherently achieved may occur or become apparent to those skilled in the art. The invention is defined by claims that issue from applications claiming benefit to this provisional application.

### DESCRIPTION OF FIGURES

FIG. 1 shows a micrograph of surface modified silver nanowires produced in Example 1.

FIG. 2 shows a micrograph of surface modified silver nanowires produced in Example 6.

FIG. 3 shows a micrograph of surface modified silver nanowires produced in Example 7.

FIG. 4 shows a micrograph of surface modified silver nanowires produced in Example 8.

FIG. 5 shows a micrograph of surface modified silver nanowires produced in Example 9.

### DESCRIPTION

All publications, patents, and patent documents referred to in this document are incorporated by reference herein in their entirety, as though individually incorporated by reference.

U.S. Provisional Patent Application No. 61/842,405, filed Jul. 3, 2013, entitled “SURFACE MODIFICATION OF METAL NANOSTRUCTURES,” is hereby incorporated by reference in its entirety. U.S. Patent application publications 2012/0148436 and 2012/0128529, both of which are entitled “NANOWIRE PREPARATION METHODS, COMPOSITIONS, AND ARTICLES,” are hereby incorporated by reference in their entirety.

### Nanostructures

The surface of selected nanostructures can be chemically or physically modified. By nanostructures, we refer to any structure, groups of structures, particulate molecule, and groups of particulate molecules of potentially varied geometric shape with shortest dimension sized between about 1 nm and about 100 nm. In some embodiments, the nanostructures may be metal nanostructures, such as, for example, metal meshes or metal nanowires, including silver nanowires. Other non-limiting examples of nanostructures include carbon nanotubes, transparent conductive oxides, and graphene.

### Surface Modifier

A surface modifier can be used to chemically or physically modify the surface of a nanostructure, such as a metal nanowire. Schematically, surface modifiers may be represented by the general formula:

A-B

The A component in the general formula may comprise a nanowire binding moiety or functional group that is capable of, or has a tendency to, bind to the surface of the metal nanowire. The B component in the general formula may comprise a surface modifying moiety or functional group that can modify a preexisting property of the metal nanowire. The A and B components are connected by at least one linkage moiety comprising one or more chemical bonds and, optionally, other atoms. By functional groups, we mean groups of atoms or bonds within molecules that are responsible for the characteristic chemical reactions of those molecules. By moiety, we mean part of a molecule that may include either whole functional groups or parts of functional groups as substructures.

In some embodiments, the A component may comprise more than one moiety or functional group. For example, an A′ moiety may be reacted with an A″ moiety to form the A component. In such a case, a B component may be added subsequently to form a surface modifier A′A″B. In some embodiments, the B component may comprise more than one moiety or functional group. For example, a B′ functional group may be reacted with a B″ functional group to form the B component. In some embodiments, the A and B components are the same, such that the nanowire binding moiety or functional group is also capability of providing the desired surface property. The A and B components may comprise any combination of moieties or functional groups. The surface modifier or its A and B components may be wholly or partly formed before attachment to the metal nanowire. In some embodiments, the surface modifier is commercially available and may be used to bind with the metal nanowire.

The surface of the metal nanowire may be modified by one or more surface modifiers. In situations where a plurality of surface modifiers is used, they may or may not be identical. In some embodiments, a sufficient amount of surface modifiers is present to form a monolayer, such as a continuous monolayer, on the surface of the metal nanowire. By monolayer, we mean a single closely packed layer of atoms, molecules, or cells.

In some embodiments, a self-assembled monolayer (SAM) of surface modifiers is formed. Self-assembled monolayers of molecules are molecular assemblies formed spontaneously on surfaces by physical or chemical adsorption and are organized into more or less large ordered domains. Monolayers are one molecule thick. By adsorption, we mean adhesion or binding of atoms, ions, or molecules from a gas, liquid, or dissolved solid to a surface. For example, SAMs may be created by the nanowire binding moieties binding to the metal nanowire by chemical reaction followed by slow organization or assembly of the surface modifying moieties further away from the metal nanowire. The assembly of the surface modifying moieties may take place simultaneously with or after the assembly of the nanowire binding moieties.

In some embodiments, a composition comprising surface-modified nanostructures may further comprise a carrier medium. In other embodiments, a composition may consist or consist essentially of the surface-modified nanostructures. For the purpose of this application, a composition consisting essentially of the surface-modified nanostructures is one in which at least about 95% of the nanostructures in the composition are surface-modified nanostructures. Some surface-modified nanostructures may be used in pharmaceutical or cosmetic formulations. For example, the surface-modified nanostructures may be used to enhance the mixing and/or delivery of medicaments, such as degree of flowability. In some embodiments, surface-modified nanostructures may be applied in protein work. In other embodiments, surface-modified nanostructures may be used for camouflage.

### Nanowire Binding Moiety

In some embodiments, the A component of a surface modifier may comprise a nanowire binding moiety. The nanowire binding moiety may bind to the metal nanowire surface.

In some embodiments, the nanowire binding moiety comprises sulfur, such as that represented by —R—S—, where R and S are covalently bonded and S is sulfur. R may represent a group comprising one or more carbon or hydrogen atoms. An example of R is a hydrocarbon, such as an alkane, alkene, alkyne, benzene, toluene, or combinations thereof. The sulfur containing nanowire binding moiety may, for example, be a thiol, sulfide, disulfide, sulfoxide, sulfone, sulfinic acid, sulfonic acid, thiocyanate, thione, or thial. In some examples, the nanowire binding moiety may be a thiol, such as methoxybenzenethiol. In some examples, the nanowire binding moiety may be a sulfide, such as diphenyl disulfide.

In some embodiments, the nanowire binding moiety may comprise phosphorus, such as that represented by —R—P—, where R and P are covalently bonded and P is phosphorus. R may represent a group comprising one or more carbon or hydrogen atoms. An example of R is a hydrocarbon, such as an alkane, alkene, alkyne, benzene, toluene, or combinations thereof. The nanowire binding moiety may, for example, be a phosphine, phosphaalkane, phosphalkene, phosphonic acid, phosphate, phosphite, or phosphodiester. In some embodiments, the nanowire binding moiety may be a phosphite, such as trimethylphosphite.

In some embodiments, the nanowire binding moiety may comprise nitrogen, such as that represented by —R—N—, where R and N are covalently bonded and N is nitrogen. R may represent a group comprising one or more carbon or hydrogen atoms. An example of R is a hydrocarbon, such as an alkane, alkene, alkyne, benzene, toluene, or combinations thereof. The nanowire binding moiety may, for example, be an amide, amine, imine, imide, azide, azo compound, cyanate, nitrate, nitrile, nitrite, nitro compound, nitroso compound, or pyridine derivative. In some embodiments, the nanowire binding moiety may be an amine, such as dimethylamine.

In some embodiments, the nanowire binding moiety may be an ionic substance. By an ionic substance, we mean a chemical substance in which ions are held together in a lattice structure by ionic bonds. The ionic substance may comprise one or more atoms that carry a positive or negative charge. For example, the nanowire binding moiety may be single atoms, such as fluorine or chlorine, or groups of atoms, such as carbonate or phosphate.

In some embodiments, the nanowire binding moiety may covalently bond to the metal nanowire surface. In some cases, the nanowire binding moiety may bind to the metal nanowire surface through a dipolar bond, which may also be referred to as a coordinate covalent bond, a coordinate link, a dative bond, or a semi-polar bond. By dipolar bond, we mean covalent bonding between two atoms in which the two electrons shared in the bond come from the same atom. Such a bond may, for example, be formed from a neutral electron pair from an atom and an ionic form of a metal atom. Any substance that contains a lone pair of electrons is capable of forming a dipolar bond. A lone pair of electrons is a valence electron pair that is available for bonding or sharing with atoms. For example, the nanowire binding moiety may contain a lone pair of electrons that is used in forming a bond with the metal nanowire. In some embodiments, the nanowire binding moiety is a neutral moiety, that is, one without charge. In some embodiments, the nanowire binding moiety may form more than one bond. In such a case, the nanowire binding moiety may bind to the metal nanowire through a dipolar bond and to at least another moiety through other bonds, such as, for example, ionic bonds or covalent bonds, such as a dipolar bond.

In some embodiments, the nanowire binding moiety comprises a nonmetal. Non-limiting examples of nonmetals include carbon, nitrogen, phosphorus, oxygen, sulfur, selenium, fluorine, chlorine, bromine, iodine, or astatine. In some embodiments, the nanowire binding moiety does not include metalloids, such as silicon.

In some embodiments, the nanowire binding moiety may bind to the metal nanowire by a displacement reaction, also referred to as a replacement reaction. For example, the metal nanowire may have a capping layer, at least some of which may be displaced by the nanowire binding moiety. In some cases, the surface modifier may comprise dodecanethiol, and the metal nanowire may comprise a polyvinylpyrrolidone (PVP) capping layer. In such cases, upon the addition of dodecanethiol, the silver nanowires may form a silver mirror, which may occur through thiol replacement of the PVP.

In some embodiments, the nanowire binding moiety does not bind to the metal nanowire by a silanization reaction.

### Surface Modifying Moiety

In some embodiments, the B component of a surface modifier may comprise a surface modifying moiety capable of modifying a property of the metal nanowire. The surface modifier may modify the metal nanowire by providing the metal nanowire with a physical property that is different in value or in kind from a preexisting property, a binding capability, or a reaction capability.

In some embodiments, the surface modifying moiety may provide the metal nanowire with a physical property that is different from a preexisting physical property. For example, the metal nanowire may exhibit a different value of an optical property, such as refractive index, haze, reflection, and transmission. In some cases, the metal nanowire may exhibit a tendency to participate in salt formation. In some cases, the metal nanowire may exhibit a different level of hydrophilicity or hydrophobicity. A hydrophilic substance may tend to dissolve by water. A hydrophobic substance may tend to repel from a mass of water.

In some embodiments, the surface modifying moiety may provide the metal nanowire with a binding capability. Such binding capability may be a precursor to providing the metal nanowire with a modified physical property. In some cases, the surface modifying moiety may comprise a ligand group for binding with metals, such as other metal nanowires or other selected metals. A ligand group may be anionic, protonic, or neutral donors that can bond to substances comprising metals or metallic surfaces. These metals may be ionic in character. Non-limiting examples of substances that comprise metals include oxides and sulfides. In some examples, the surface modifying moiety may provide the metal nanowire with a binding capability, such as a chelation capability. In such cases, the ligand group may be a polydentate ligand, that is, a multiple bonded ligand or a ligand with multiple atoms that can bind to a metal. In some embodiments, the ligand group that provides chelation capability may be an organic compound, which may be referred to as a chelant, chelator, chelating agent, or sequestering agent. In applications where the transparent conductive film comprises a plurality of metal nanowires, ligand groups may form connections between metal nanowires that may increase the conductivity of the transparent conductive film.

In some embodiments, the surface modifying moiety may provide the metal nanowire with a reaction capability. Such reaction capability may be a precursor to providing the metal nanowire with a modified physical property. In some cases, the surface modifying moiety may comprise polymerizable groups. Such polymerizable groups may be capable of, for example, reacting with other substances to yield certain results, such as enhanced binding capability or new binding capabilities with other substances or new or enhanced properties or characteristics of the metal nanowire. In some cases, the polymerizable group affords the metal nanowire the ability to add subsequent polymer groups to its surface. In such cases, this may fix wires in place and afford abrasion resistance to the film comprising such wires. In some embodiments, the surface modifying moiety may comprise a substance that provides new or enhanced reducing capability to the metal nanowire. In such cases, the reducing capability may provide corrosion protection. For example, if the metal nanowire is oxidized by the environment, the reducing substance may in turn reduce it back.

In some embodiments, the surface modifying moiety may comprise a reaction capability, such as a color changing capability. In applications where a conductive film comprises metal nanowires with such color changing capability, a color may be imparted to the film. In some embodiments, the surface modifying moiety may comprise a reaction capability, such as buffering capability. In some cases, a metal nanowire with buffering capability may help keep a solution comprising the metal nanowire at a relatively constant pH. This may be useful in biological or medicinal applications.

In some embodiments, the surface modifying moiety comprises an amine group. In such cases, the addition of hydrochloric acid may produce a salt. In some cases, salt formation may render the metal nanowire surface hydrophilic. In some cases, the salt may enable nanowires to grow to larger average primary particle sizes.

In some embodiments, the surface modifying moiety comprises an epoxy group. In some cases, the epoxy group affords the metal nanowire with polymerizability or the capability to add subsequent polymer groups. In some cases, this may fix metal nanowires in place and enhance abrasion resistance.

In some embodiments, the surface modifying moiety comprises a carboxylate group. In some cases, the carboxylate group affords the metal nanowire with the capability to bind with other metals, such as metal nanowires with or without a carboxylate group. In some cases, this may increase the number and quality of connections among metal nanowires and increase the conductivity of a film comprising such metal nanowires. In some cases, a metal is introduced, and the carboxylate group may bind with the metal, resulting in a change in refractive index.

In some embodiments, the surface modifying moiety comprises a trifluoromethyl group. In some cases, a metal nanowire with the trifluoromethyl group as a surface modifying moiety may render the metal nanowire surface hydrophobic and produce substantially non-agglomerated particles, such as powders. These powders may be re-dispersed, and further characteristics of the powders may subsequently be modified.

### Linkage Component

In some embodiments, a surface modifier may comprise a linkage component capable of providing a bonding connection between the nanowire binding moiety and the surface modifying moiety. The linkage component may be capable of any suitable type of bonding, such as covalent, ionic, or metallic bonding. In some embodiments, the linkage component is a bond. In some embodiments, the linkage component comprises a linkage moiety that provides the bond. The surface modifier may comprise one or more linkage moieties between the nanowire binding moiety and the surface modifying moiety. In some embodiments, the linkage moiety is a neutral moiety, that is, one without charge.

In some embodiments, a linkage moiety may covalently bond the nanowire binding moiety and the surface modifying moiety. In such cases, the linkage moiety may comprise a hydrocarbon, such as an alkane, alkene, alkyne, benzene, toluene, or combinations thereof. The hydrocarbon may be branched. In the case of a branched hydrocarbon, a substituent is replaced by another covalently bonded chain of the same or different type. The hydrocarbon may be substituted. In the case of a substituted hydrocarbon, one or more hydrogen atoms is replaced by one or more non-hydrogen atoms or groups.

In some embodiments, a linkage moiety may provide metallic bonding between the nanowire binding moiety and the surface modifying moiety. In some embodiments, a linkage moiety may provide organometallic bonding between the nanowire binding moiety and the surface modifying moiety.

In some embodiments, the linkage moiety comprises a nonmetal. Non-limiting examples of nonmetals include carbon, nitrogen, phosphorus, oxygen, sulfur, selenium, fluorine, chlorine, bromine, iodine, and astatine. In some embodiments, the linkage moiety does not include metalloids, such as silicon.

### Exemplary Embodiments

U.S. Provisional Patent Application No. 61/842,405, filed Jul. 3, 2013, entitled “SURFACE MODIFICATION OF METAL NANOSTRUCTURES,” which is hereby incorporated by reference in its entirety, disclosed the following 39 non-limiting exemplary embodiments:

A. A nanostructure comprising:

at least one metal nanowire comprising at least one surface, and

at least one surface modifier disposed on the at least one surface, the at least one surface modifier comprising at least one linkage component, at least one nanowire binding moiety bonded to the at least one linkage component, and at least one surface modifying moiety also bonded to the at least one linkage component,

wherein the at least one nanowire binding moiety is bonded to the at least one surface.

B. The nanostructure of embodiment A, wherein the linkage component comprises a linkage moiety.
C. The nanostructure of embodiment B, wherein the linkage moiety comprises a hydrocarbon.
D. The nanostructure of embodiment B, wherein the linkage moiety comprises an organometallic component.
E. The nanostructure of embodiment B, wherein the linkage moiety comprises a nonmetal.
F. The nanostructure of embodiment B, wherein the linkage moiety comprises a neutral moiety.
G. The nanostructure of embodiment B, wherein the linkage moiety does not comprise silicon.
H. The nanostructure of any of embodiments A-G, wherein the nanowire binding moiety comprises sulfur, nitrogen, phosphorus, or an ionic substance.
J. The nanostructure of any of embodiments A-G, wherein the nanowire binding moiety comprises sulfur.
K. The nanostructure of any of embodiments A-G, wherein the nanowire binding moiety comprises phosphorus.
L. The nanostructure of any of embodiments A-G, wherein the nanowire binding moiety comprises nitrogen.
M. The nanostructure of any of embodiments A-G, wherein the nanowire binding moiety comprises an ionic component.
N. The nanostructure of any of embodiments A-G, wherein the nanowire binding moiety binds to the at least one surface through a dipolar bond.
P. The nanostructure of any of embodiments A-N, wherein the surface modifying moiety comprises a ligand.
Q. The nanostructure of any of embodiments A-N, wherein the surface modifying moiety comprises an amine group.
R. The nanostructure of any of embodiments A-N, wherein the surface modifying moiety comprises an epoxy group.
S. The nanostructure of any of embodiments A-N, wherein the surface modifying moiety comprises a carboxylate group.
T. The nanostructure of any of embodiments A-N, wherein the surface modifying moiety comprises a trifluoromethyl group.
U. The nanostructure of any of embodiments A-N, wherein the surface modifying moiety comprises a thiol group.
V. The nanostructure of any of embodiments A-U, wherein the nanowire binding moiety comprises a thiol group.
W. The nanostructure of any of embodiments A-U, wherein the nanowire binding moiety comprises at least one fluorine atom.
X. The nanostructure of any of embodiments A-W, wherein the nanostructure is hydrophobic.
Y. The nanostructure of any of embodiments A-W, wherein the nanostructure is hydrophilic.
Z. The nanostructure of embodiment A, wherein the surface modifier comprises dodecanethiol.
AA. The nanostructure of embodiment A, wherein the surface modifier comprises a dithiol.
AB. The nanostructure of embodiment A, wherein the surface modifier comprises 1,9-nonanedithiol.
AC. The nanostructure of embodiment A, wherein the surface modifier comprises 1H,1H,2H,2H-perfluorodecanethiol.
AD. A method comprising:

providing at least one metal nanowire comprising at least one surface,

providing at least one surface modifier comprising at least one linkage component, at least one nanowire binding moiety bonded to the at least one linkage component, and at least one surface modifying moiety also bonded to the at least one linkage component, wherein the at least one nanowire binding moiety is bonded to the at least one surface; and

combining the at least one metal nanowire and the at least one surface modifier,

wherein, after combining the at least one nanowire and the at least one surface modifier, the at least one surface modifier is disposed on the at least one surface of the at least metal nanowire.

AE. The method of embodiment AD, wherein, prior to combining the at least one metal nanowire and the at least one surface modifier, the at least one metal nanowire exhibits a preexisting set of properties, and after the combining the at least one metal nanowire and the at least one surface modifier, the at least one metal nanowire exhibits a consequent set of properties, and further wherein the consequent set of properties is different from the preexisting set of properties.
AF. The method of embodiment AE, wherein the preexisting set of properties comprises a preexisting binding capability to bind with other substances and the consequent set of properties comprises a consequent binding capability to bind with other substances that is different from the preexisting binding capability to bind with other substances.
AG. The method of embodiment AE, wherein the preexisting set of properties comprises a preexisting reaction capability to react with other substances and the consequent set of properties comprises a consequent reaction capability to react with other substances that is different from the preexisting reaction capability to react with other substances.
AH. The method of embodiment AE, wherein the preexisting set of properties comprises a preexisting physical property and the consequent set of properties comprises a consequent physical property that is different from the preexisting physical property.
AJ. The method of embodiment AH, wherein the preexisting physical property comprises a preexisting optical property and the consequent physical property comprises a consequent optical property that is different from the preexisting optical property.
AK. The method of embodiment AJ, wherein the preexisting optical property comprises a preexisting haze and the consequent optical property comprises a consequent haze that is different from the preexisting haze.
AL. The method of embodiment AH, wherein the preexisting optical property comprises a preexisting refractive index and the consequent optical property comprises a consequent refractive index that is different from the preexisting refractive index.
AM. The method of embodiment AH, wherein the preexisting optical property comprises a preexisting reflection and the consequent optical property comprises a consequent reflection that is different from the preexisting reflection.
AN. The method of embodiment AH, wherein the preexisting optical property comprises a preexisting transmission and the consequent optical property comprises a consequent transmission that is different from the preexisting transmission.
AP. The method of embodiment AH, wherein the preexisting physical property comprises a preexisting capability to form a salt and the consequent physical property comprises a consequent capability to form a salt that is different from the preexisting capability to form a salt.
AQ. The method of any of embodiments AH-AP, wherein the nanowire binding moiety binds to the surface of the nanowire by a displacement reaction.

### EXAMPLES

### Example 1

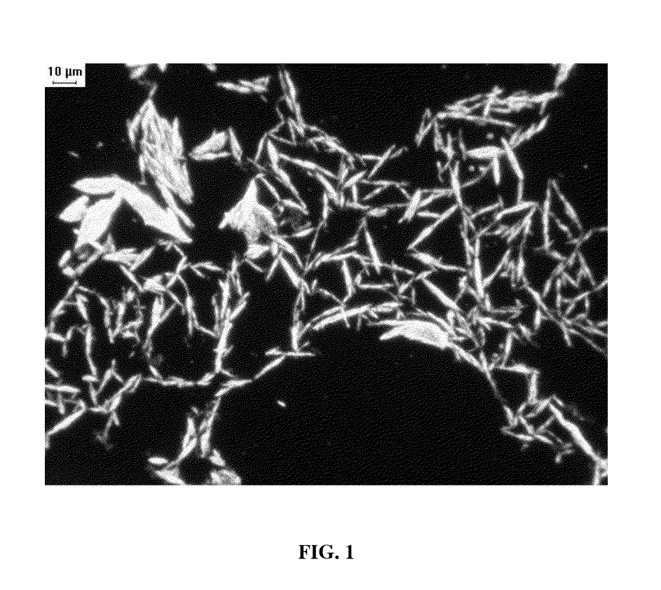

Silver nanowires (AgNW) were prepared and surface modified by dodecanethiol. Under N₂ headspace positive pressure, a 100 mL reaction flask containing 70 mL of propylene glycol (PG) and 1.38 g polyvinylpyrrolidone (PVP) was heated to 110.0±0.3° C. with stirring at 200 rpm. With the hood lights turned off, a freshly prepared mixture of 0.2 mL of 0.21 M MnCl₂.4H₂O in PG and 5.0 mL AgNO₃ in PG was added at 0.5 mL/min. The reaction was allowed to take place for a total of 160 minutes during which the hood lights remained off. After a total of 160 minutes, 0.2 g of dodecanethiol was added to the reaction mixture. An immediate silver mirror formed. Larger agglomerates of assembled AgNW formed a dispersion, which appeared as clusters, as shown in FIG. 1.

### Example 2

### Prophetic

Silver nanowires are prepared according to the materials and methods disclosed in U.S. patent application publications 2012/0148436 and 2012/0128529, both of which are entitled “Nanowire Preparation Methods, Compositions, and Articles,” and both of which are hereby incorporated by reference in their entirety. A suitable amount of a surface modifier that has an amine group as a surface modifying moiety and a thiol group as a metal binding nanowire moiety is added to the mixture of silver nanowires. The addition of HCl produces a salt that affords a hydrophilic characteristic to the surface of the nanowires.

### Example 3

### Prophetic

Silver nanowires are prepared according to the materials and methods disclosed in US patent application publications 2012/0148436 and 2012/0128529, both of which are entitled “Nanowire Preparation Methods, Compositions, and Articles,” and both of which are hereby incorporated by reference in their entirety. A suitable amount of a surface modifier that has an epoxy group as a surface modifying moiety and a thiol group as a metal binding nanowire moiety is added to the mixture of silver nanowires. The epoxy group affords polymerizability or the capability to add subsequent polymer groups. This characteristic may fix wires in place or enhance abrasion resistance.

### Example 4

### Prophetic

Silver nanowires are prepared according to the materials and methods disclosed in US patent application publications 2012/0148436 and 2012/0128529, both of which are entitled “Nanowire Preparation Methods, Compositions, and Articles,” and both of which are hereby incorporated by reference in their entirety. A suitable amount of a surface modifier that has a carboxylate group as a surface modifying moiety and a thiol group as a metal binding nanowire moiety is added to the mixture of silver nanowires. The carboxylate group may provide the nanowire surface with the capability or tendency to bind with other metals. In some cases, the number and quality of connections among nanowires may increase, which may increase conductivity.

### Example 5

### Prophetic

Silver nanowires are prepared according to the materials and methods disclosed in US patent application publications 2012/0148436 and 2012/0128529, both of which are entitled “Nanowire Preparation Methods, Compositions, and Articles,” and both of which are hereby incorporated by reference in their entirety. A suitable amount of a surface modifier that has a —CF₃ group as a surface modifying moiety and a thiol group as a metal binding nanowire moiety is added to the mixture of silver nanowires. The surface of the nanowire becomes hydrophobic, and the metal nanowires are non-agglomerated and dispersible.

### Example 6

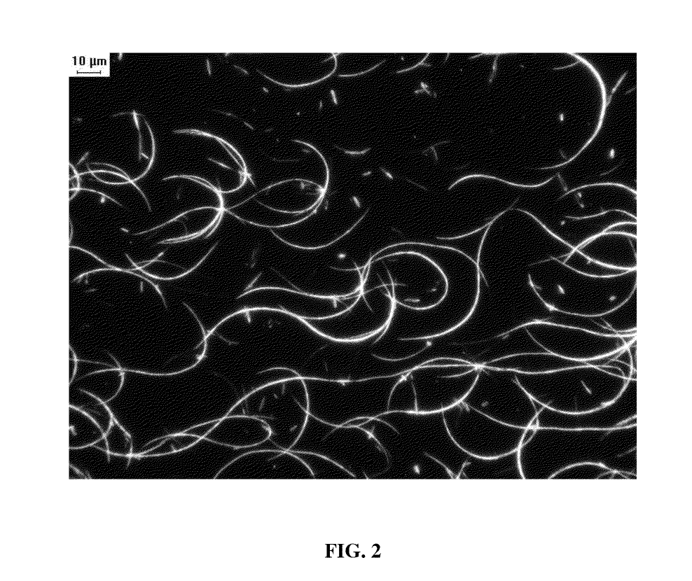

Silver nanowires were prepared and purified to obtain a 4.1 wt % silver nanowire dispersion in isopropanol, which corresponds to 0.032 g silver nanowire per 1 mL of solution. 9.0 mL of isopropanol was added to 1.0 mL of the silver nanowire dispersion and mixed by gentle shaking for 10 minutes. One drop of dithiol was added and mixed by gentle shaking for 2 hours. The mixture was allowed to stand overnight. The mixture was centrifuged the next day at 500 G for 30 min, decanted and redispersed in 0.5 mL isopropanol. FIG. 2 is a micrograph showing agglomeration of silver nanowires in longer strands.

### Example 7

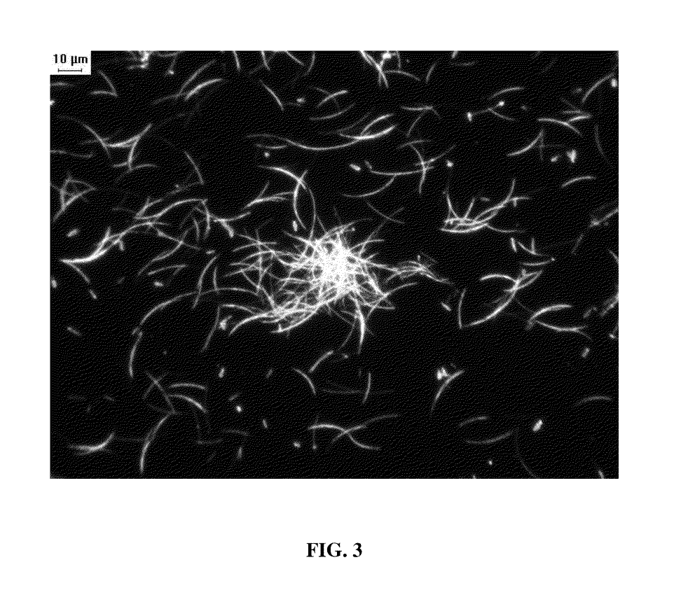

Silver nanowires were prepared and purified to obtain a 4.1 wt % silver nanowire dispersion in isopropanol, which corresponds to 0.032 g silver nanowire per 1 mL of solution. 9.0 mL of isopropanol was added to 1.0 mL of the silver nanowire dispersion and mixed by gentle shaking for 10 minutes. One drop of 1,9-nonanedithiol was added and mixed by gentle shaking for 2 hours. The mixture was allowed to stand overnight. The mixture was centrifuged the next day at 500 G for 30 min, decanted and redispersed in 0.5 mL isopropanol. FIG. 3 is a micrograph showing agglomeration of some silver nanowires in a cluster.

### Example 8

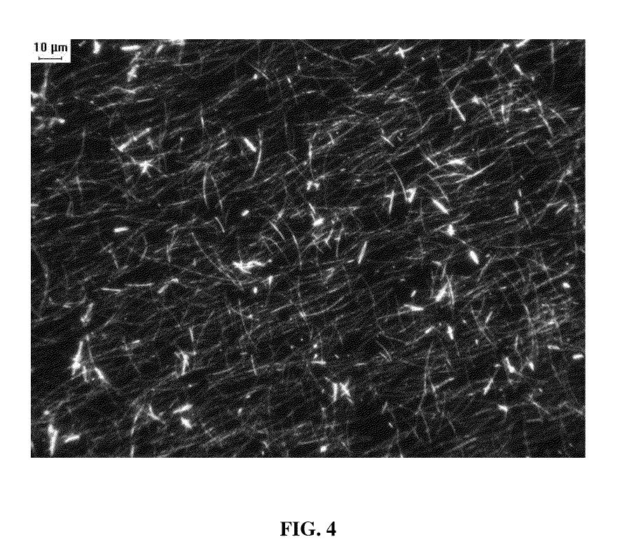

Silver nanowires were prepared and purified to obtain a 4.1 wt % silver nanowire dispersion in isopropanol, which corresponds to 0.032 g silver nanowire per 1 mL of solution. 9.0 mL of isopropanol was added to 1.0 mL of the silver nanowire dispersion and mixed by gentle shaking for 10 minutes. One drop of 1H,1H,2H,2H-perfluorodecanethiol was added and mixed by gentle shaking for 2 hours. The mixture was allowed to stand overnight. The mixture was centrifuged the next day at 500 G for 30 min, decanted and redispersed in 0.5 mL isopropanol. FIG. 4 is a micrograph showing substantially non-agglomerated silver nanowires.

### Example 9

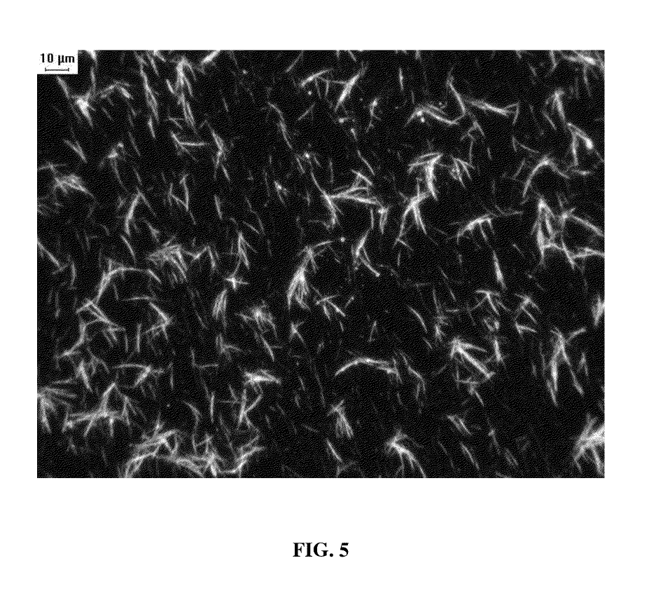

Silver nanowires were prepared and purified to obtain a 4.1 wt % silver nanowire dispersion in isopropanol, which corresponds to 0.032 g silver nanowire per 1 mL of solution. 9.0 mL of isopropanol was added to 1.0 mL of the silver nanowire dispersion and mixed by gentle shaking for 10 minutes. The mixture was centrifuged at 500 G for 30 min, decanted, and redispersed in 0.5 mL isopropanol. FIG. 5 is a micrograph showing agglomeration of silver nanowires in multiple clusters.

### Example 10

This example demonstrates use of a silver carbene surface complex. To 3 mL of a 1.7 wt % silver nanowire dispersion in isopropanol was added 100 mg of 1,3-bis-(2,6-diiso-propyl-phenyl)-imidazolinium chloride (Aldrich). The resulting dispersion was diluted with isopropanol to 10 mL, was shaken for 3 hrs, and was centrifuged at 900 G for 20 minutes. The supernatant was decanted and the solids were redispersed in water. A floating flocculated solid resulted, which demonstrated the conversion of hydrophilic silver nanowires into a hydrophobic solid.

### Example 11

To 3 mL of a 1.7 wt % silver nanowire dispersion in isopropanol was added 100 mg of 1,3-bis(1-adamantyl)-imidazolium tetra-fluoroborate (Aldrich). The resulting dispersion was diluted with isopropanol to 10 mL, was shaken for 3 hrs, and was centrifuged at 900 G for 20 minutes. The supernatant was decanted and the solids were redispersed in water. A floating flocculated solid resulted, which demonstrated the conversion of hydrophilic silver nanowires into a hydrophobic solid.

### Example 12

To 3 mL of a 1.7 wt % silver nanowire dispersion in isopropanol was added 100 mg of 5,5′-bis(mercaptomethyl)-2,2′-bipyridine (Aldrich). The resulting dispersion was diluted with isopropanol to 10 mL, was shaken for 3 hrs, and was centrifuged at 900 G for 20 minutes. The supernatant was decanted and the solids were redispersed in water. 5 mg of ferrous ammonium sulfate was added to a sample of the dispersion, which turned pink. This demonstrates chelation of the bipyridine group to Fe²⁺, indicative of the Fe²⁺ being attached to the silver nanowire surface via the thiol-bypyridine ligand.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A nanostructure comprising:
at least one metal nanowire comprising at least one surface, and
at least one surface modifier disposed on the at least one surface, the at least one surface modifier comprising at least one linkage component, at least one nanowire binding moiety bonded to the at least one linkage component, and at least one surface modifying moiety also bonded to the at least one linkage component,
wherein the at least one nanowire binding moiety is bonded to the at least one surface.

2. The nanostructure of claim 1, wherein the linkage component comprises a hydrocarbon, an organometallic component, a nonmetal, or a neutral moiety.

3. The nanostructure of claim 1, wherein the linkage component does not comprise silicon.

4. The nanostructure of claim 1, wherein the nanowire binding moiety comprises sulfur, nitrogen, phosphorus, or an ionic substance.

5. The nanostructure of claim 1, wherein the nanowire binding moiety comprises at least one fluorine atom.

6. The nanostructure of claim 1, wherein the nanowire binding moiety comprises carbon.

7. The nanostructure of any of claim 1, wherein the nanowire binding moiety binds to the at least one surface through a dipolar bond.

8. The nanostructure of claim 1, wherein the surface modifying moiety comprises an amine group, an epoxy group, a carboxylate group, a trifluoromethyl group, or a thiol group.

9. The nanostructure of claim 1, wherein the surface modifier comprises dodecanethiol.

10. The nanostructure of claim 1, wherein the surface modifier comprises a dithiol.

11. The nanostructure of claim 1, wherein the surface modified comprises a carbene.

12. The nanostructure of claim 1, wherein the surface modifier comprises 1,9-nonanedithiol.

13. The nanostructure of claim 1, wherein the surface modifier comprises 1H,1H,2H,2H-perfluorodecanethiol.

14. The nanostructure of claim 1, wherein the surface modifier comprises 1,3-bis-(2,6-diiso-propyl-phenyl)-imidazolinium chloride.

15. The nanostructure of claim 1, wherein the surface modifier comprises 1,3-bis(1-adamantyl)-imidazolium tetra-fluoroborate.

16. The nanostructure of claim 1, wherein the surface modifier comprises 5,5′-bis(mercaptomethyl)-2,2′-bipyridine.

17. A method comprising:
providing at least one metal nanowire comprising at least one surface,
providing at least one surface modifier comprising at least one linkage component, at least one nanowire binding moiety bonded to the at least one linkage component, and at least one surface modifying moiety also bonded to the at least one linkage component, wherein the at least one nanowire binding moiety is bonded to the at least one surface; and
combining the at least one metal nanowire and the at least one surface modifier,
wherein, after combining the at least one nanowire and the at least one surface modifier, the at least one surface modifier is disposed on the at least one surface of the at least metal nanowire.
